(19) United States
(12) Patent Application Publication
(10) Pub. No.: US 2026/0252265 A1
(43) Pub. Date: Aug. 27, 2026

(54) DRAM VALUE GENERATOR

(71) Applicant: Micron Technology, Inc., Boise, ID (US)

(72) Inventor: Khalil Gammoh, Meridian, ID (US)

(21) Appl. No.: 19/546,067

(22) Filed: Feb. 20, 2026

Related U.S. Application Data
(60) Provisional application No. 63/762,962, filed on Feb. 25, 2025.

(51) Int. Cl. G06F 3/06

(52) U.S. Cl. CPC G06F 3/0655; G06F 3/0604; G06F 3/0632; G06F 3/0673

(57) ABSTRACT

Various examples are directed to systems and methods for generating data values using a DRAM memory array comprising a number of memory cells. A memory control circuit may interrupt a first refresh of the memory array at a first time after the first refresh. The first refresh of the memory array may comprise refreshing a first portion of the number of memory cells and, after refreshing the first portion of the number of memory cells, refreshing a second portion of the number of memory cells. The memory control circuit may, after interrupting the first refresh of the memory array, read a portion of the number of memory cells to generate first read data. The memory control circuit may also apply a cryptographic function to a first portion of the first read data corresponding to a first set of the number of memory cells to generate a first data value.

### PRIORITY APPLICATION

This application claims the benefit of priority to U.S. Provisional Application Ser. No. 63/762,962, filed Feb. 25, 2025, which is incorporated herein by reference in its entirety.

### BACKGROUND

Memory devices are typically provided as internal, semiconductor, integrated circuits (ICs) in computers or other electronic devices. There are many different types of memory, including volatile and non-volatile memory. Volatile memory requires power to maintain its data and includes random-access memory (RAM), dynamic random-access memory (DRAM), static RAM (SRAM), or synchronous dynamic random-access memory (SDRAM), among others. Non-volatile memory can retain stored data when not powered and includes flash memory, read-only memory (ROM), electrically erasable programmable ROM (EEPROM), erasable programmable ROM (EPROM), resistance-variable memory, such as phase-change random-access memory (PCRAM), resistive random-access memory (RRAM), magnetoresistive random-access memory (MRAM), or three-dimensional (3D) XPoint™ memory, among others. Properties of memory devices and other electronic devices can be improved by enhancements to the design and fabrication of components of the electronic devices such as, but not limited to, memory devices in an IC for the electronic devices.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an environment including a memory device.

FIG. 2 is a schematic of an electrical arrangement of components of an embodiment of an example DRAM device with each of the memory cells having a GAA transistor coupled to a capacitor.

FIG. 3 is a diagram showing an example arrangement of the memory array of FIG. 1 and illustrating an example execution of an interrupted refresh of the memory array of FIG. 1.

FIG. 4 is a chart showing another example implementation of number generation using DRAM.

FIG. 5 is a flowchart showing one example of a process flow illustrating the interrupting of a refresh at the memory device of FIG. 1.

FIG. 6 is a flowchart showing one example of a process flow that may be executed in the environment of FIG. 1 to generate a number, such as a random number and/or a unique, repeatable number using a DRAM.

FIG. 7 is a flowchart showing one example of a process flow that may be executed by the memory control circuit of FIG. 1 to identify stable and unstable memory cells at the memory array of FIG. 1.

FIG. 8 is a flowchart showing one example of a process flow for selecting a time between the refresh and the reset.

FIG. 9 is a block diagram illustrating an example of a machine upon which one or more embodiments may be implemented.

### DETAILED DESCRIPTION

Various examples described herein are directed to memory devices and systems for using memory devices to generate numbers. For example, various examples described herein utilize the memory array of a DRAM memory device to generate a random number. Also, various examples described herein utilize the memory array of the DRAM memory device to generate a physical unclonable function (PUF).

There are various computer processing tasks for which it is desirable to obtain random numbers. For example, random numbers are regularly used in cryptography, cryptocurrencies, computer-implemented simulations, network management, and other applications. The randomness of random numbers can affect the quality of corresponding processing. For example, consider a cryptography application. Using a random number that is less random may cause cryptographic operations to be more predictable and, therefore, less secure.

In various examples, computing devices can be programmed to generate random numbers algorithmically. Because algorithmically generated random numbers are determined deterministically, they are not perfectly random. Accordingly, the performance of processing tasks such as for cryptography, may suffer.

There are also various computer processing tasks for which it is desirable to obtain unique and repeatable numbers. For example, unique and repeatable numbers may be used to generate cryptographic keys on a storage volume, such as an SSD, UFS, MMC, eMMC, etc. A storage volume can use cryptographic keys, for example, for security purposes. Some storage volumes receive commands that are encrypted or otherwise cryptographically signed using a cryptographic key. If the command is not encrypted or signed using the cryptographic expected by the storage volume, the storage volume can decline to execute the command. Also, in some examples, a storage volume can encrypt and/or decrypt stored data using a cryptographic key.

Various examples address these and other challenges using the memory array of a DRAM device to generate random numbers and/or unique, repeatable values such as a PUF. A memory control circuit of the DRAM device may be programmed to execute a refresh of the memory array. During a refresh, the memory control circuit reads the charge level at various cells of the memory array and restores the charge of the memory cells to bring them to an expected charge level. The memory control circuit may interrupt the refresh of the memory array, for example, by resetting the memory device while the refresh is executing. After the lease set, the memory array, or a portion of the memory cells thereof, may be read. The read data may comprise stable bits read from stable memory cells and unstable bits read from unstable memory cells. The memory control circuit may use the unstable bits as a random number. In addition to, or instead of, using the unstable bits as a random number, the memory circuit may use the stable bits as a unique and repeatable number, such as a PUF. In some examples, the random number generated as described herein may be a true random number.

A PUF is a unique data value that can be detected from a subject semiconductor device, such as a memory device, based on the properties of the subject semiconductor device. The PUF may be described as and/or used as a signature or component identifier of the subject semiconduct him or device. For example, small process variations in the manufacture of memory and other semiconductor devices can cause otherwise similar semiconductor devices to exhibit slightly different behavior. These small differences in behavior can be detected and used to generate PUF values. PUF values are data derived from the unique properties of one or more subject semiconductor components. In this example, small variations in the way that the memory cells of the memory array 120 responds to the interrupted refresh cause the memory cells to be either stable or unstable, facilitating the generation of a PUF and/or a random number as described herein.

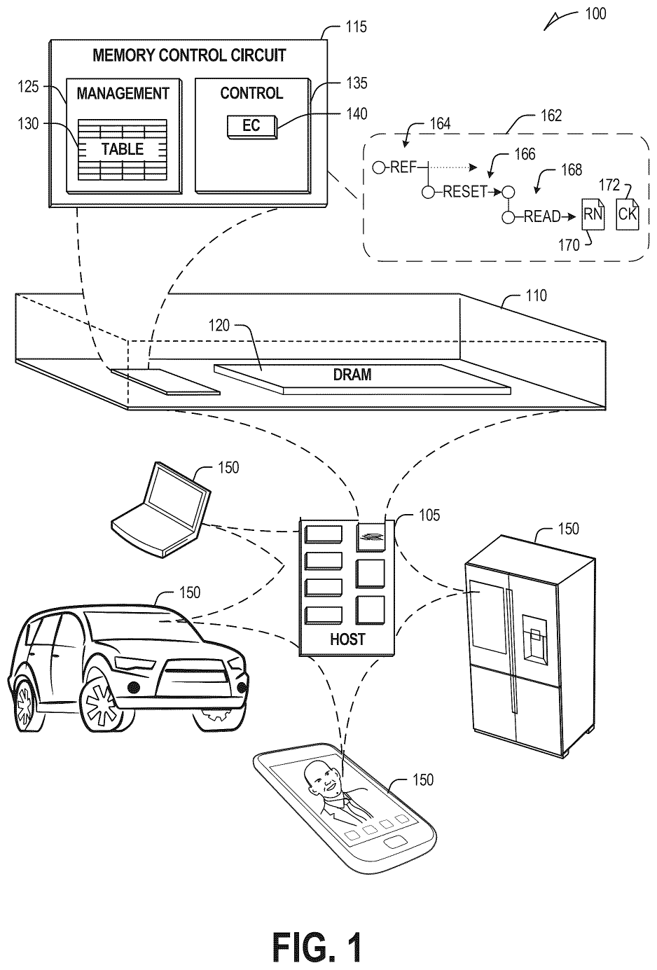

FIG. 1 illustrates an example of an environment 100 including a host device 105 and a memory device 110 configured to communicate over a communication interface. An electronic device comprising the host device 105 and/or the memory device 110 may be included in a variety of products 150, such as Internet of Things (IoT) devices (e.g., a refrigerator or other appliance, sensor, motor or actuator, mobile communication device, automobile, drone, and/or the like), computers (e.g., laptop computers, desktop computers, and/or the like) to support processing, communications, or control of the product 150.

The memory device 110 includes a memory control circuit 115 and a memory array 120 including, for example, a number of individual memory die (e.g., one or more 2D or 3D DRAM arrays). In 3D architecture semiconductor memory technology, vertical structures are stacked, increasing the number of tiers, physical pages, and accordingly, the density of a memory device (e.g., a storage device). In an example, the memory device 110 can be a discrete memory or storage device component of the host device 105. In other examples, the memory device 110 can be a portion of an integrated circuit (e.g., system on a chip (SOC), etc.), stacked or otherwise included with one or more other components of the host device 105.

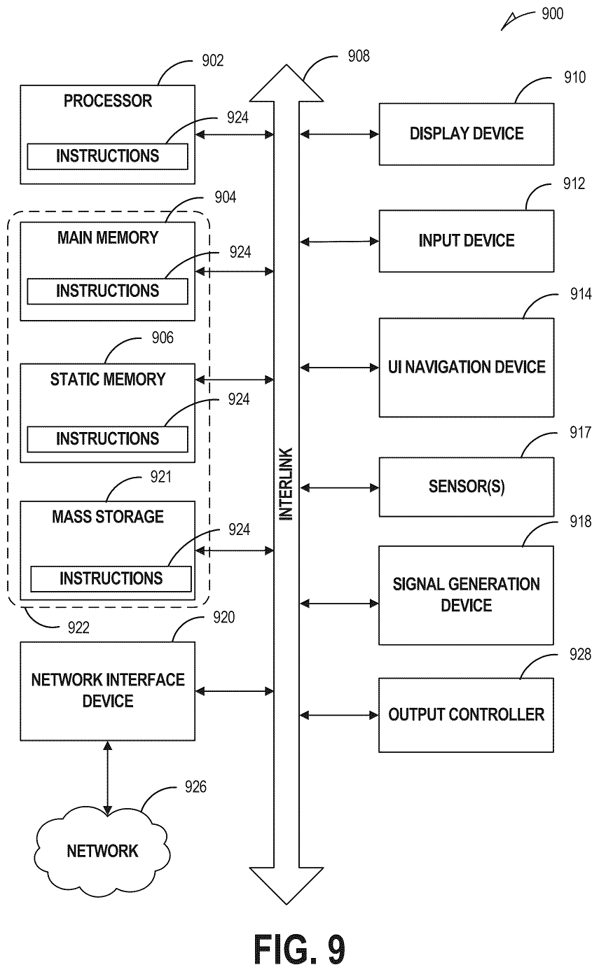

One or more communication interfaces can be used to transfer data between the memory device 110 and one or more other components of the host device 105, such as a Serial Advanced Technology Attachment (SATA) interface, a Peripheral Component Interconnect Express (PCIe) interface, a Universal Serial Bus (USB) interface, or one or more other connectors or interfaces. The host device 105 can include a host system, an electronic device, a processor, a memory card reader, or one or more other electronic devices external to the memory device 110. In some examples, the host device 105 may be a machine having some portion, or all, of the components discussed in reference to the machine 900 of FIG. 9.

Electronic devices, such as mobile electronic devices (e.g., smartphones, tablets, etc.), electronic devices for use in automotive applications (e.g., automotive sensors, control units, driver-assistance systems, passenger safety or comfort systems, etc.), and internet-connected appliances or devices (e.g., IoT devices, etc.), have varying storage needs depending on, among other things, the type of electronic device, use environment, performance expectations, etc.

Electronic devices can be broken down into several main components: a processor (e.g., a central processing unit (CPU) or other main processor); memory (e.g., one or more volatile or non-volatile RAM memory device, such as DRAM, mobile or low-power double-data-rate synchronous DRAM (DDR SDRAM), etc.); and a storage device (e.g., non-volatile memory (NVM) device, such as flash memory, ROM, an SSD, an MMC, or other memory card structure or assembly, etc.). In certain examples, electronic devices can include a user interface (e.g., a display, touch-screen, keyboard, one or more buttons, etc.), a graphics processing unit (GPU), a power management circuit, a baseband processor, or one or more transceiver circuits, etc.

The memory control circuit 115 can receive instructions from the host device 105, and can communicate with the memory array 120, such as to transfer data to (e.g., write or erase) or from (e.g., read) one or more of the memory cells, planes, sub-banks, banks, or pages of the memory array. The memory control circuit 115 can include, among other things, circuitry or firmware, including one or more components or integrated circuits. For example, the memory control circuit 115 can include one or more memory control units, circuits, or components configured to control access across the memory array 120 and to provide a translation layer between the host device 105 and the memory device 110. The memory control circuit 115 can include one or more input/output (I/O) circuits, lines, or interfaces to transfer data to or from the memory array 120. The memory control circuit 115 can include a memory manager 125 and an array controller 135.

The memory manager 125 can include, among other things, circuitry or firmware, such as a number of components or integrated circuits associated with various memory management functions. For purposes of the present description example memory operation and management functions will be described in the context of DRAM memory. Persons skilled in the art will recognize that other forms of non-volatile memory may have analogous memory operations or management functions. Such DRAM management functions include memory cell refresh, error detection or correction, or one or more other memory management functions. The memory manager 125 can parse or format host commands (e.g., commands received from a host) into device commands (e.g., commands associated with the operation of a memory array, etc.), or generate device commands (e.g., to accomplish various memory management functions) for the array controller 135 or one or more other components of the memory device 110.

The memory manager 125 can include a set of management tables 130 configured to maintain various information associated with one or more components of the memory device 110 (e.g., various information associated with a memory array or one or more memory cells coupled to the memory control circuit 115). For example, the management tables 130 can include information regarding one or more error counts (e.g., a write operation error count, a read bit error count, a read operation error count, an erase error count, etc.) for one or more portions of the memory cells coupled to the memory control circuit 115.

The array controller 135 can include, among other things, circuitry or components configured to control memory operations associated with writing data to, reading data from, or erasing one or more memory cells of the memory device 110 coupled to the memory control circuit 115. The memory operations can be based on, for example, host commands received from the host device 105, or internally generated by the memory manager 125 (e.g., in association with refreshing, error detection or correction, etc.).

The array controller 135 can include an error correction circuit 140. In some examples, the error correction circuit 140 is arranged to implement error correction code (ECC) or another suitable error correction algorithm. For example, when data is to be written to a page or other subunit of memory cells of the memory array 120, the error correction circuit 140 may generate one or more parity bits based on the data. The parity bits are written to one or more memory cells at the array, for example, in association with the data. When data is read from the memory array, the data and its associated parity bit or bits are provided to the error correction circuit 140. The error correction circuit may use the parity bits to, if possible, detect and correct any bit errors that may have occurred. In some examples, the error correction circuit 140 may be implemented in software that is executed by a processor, a microcontroller, or other suitable hardware at the memory control circuit 115.

The memory array 120 can include a number of memory cells arranged in, for example, a number of devices, planes, sub-banks, banks, pages, and/or the like. In some examples, the memory array 120 may be arranged in three dimensions physically, and/or logically. For example, memory cells in the memory array 120 may be arranged into rows, columns, banks, and other subdivisions. In some examples, the memory array 120 can be divided into banks. Each bank of the memory array may be a group of memory cells that share a common internal bus. Accordingly, each bank may comprise a number of rows and a number of columns.

In some examples, the memory array 120 may be read and/or written by page. A page of data can include a number of bytes of user data (e.g., a data payload including a number of sectors of data) and its corresponding metadata, the size of the page often refers only to the number of bytes used to store the user data. As an example, a page of data having a page size of 128 bits of user data (e.g., 8 columns of 8 bits) as well as a number of bytes (e.g., 32 B, 54 B, 224 B, etc.) of metadata corresponding to the user data, such as integrity data (e.g., error detecting or correcting code data), address data (e.g., logical address data, etc.), or other metadata associated with the user data.

Different types of memory cells or memory arrays can provide for different page sizes or may require different amounts of metadata associated therewith. For example, different memory device types may have different bit error rates, which can lead to different amounts of metadata necessary to ensure the integrity of the page of data (e.g., a memory device with a higher bit error rate may require more bytes of parity data than a memory device with a lower bit error rate).

The memory control circuit 115 and memory array 120 can be configured to generate a random number and/or unique, repeatable number such as a PUF. For example, a breakout window 162 illustrates operations that may be executed at the memory array 120 by the memory control circuit 115 to generate a number such as a random number and/or a unique, repeatable number such as a PUF.

The memory control circuit 115 executes a refresh 164 of the memory array 120. The memory control circuit 115 may be programmed to implement the refresh in a staggered manner. For example, the memory control circuit 115 may be programmed to avoid refreshing all portions of the memory array 120 in parallel. Instead, the memory control circuit 115 may first begin refreshing one portion of the memory cells of the memory array 120 and then, subsequently, begin refreshing another portion of the memory cells, and so on. The refreshing of different portions of the memory array 120 may overlap in time or may not overlap in time. In some examples, the refresh is staggered by bank of the memory array 120. For example, the memory control circuit 115 may first begin refreshing one bank of memory cells at the memory array 120 and, subsequently, begin refreshing another bank of memory cells at the memory array 120, and so on.

In some examples, the memory control circuit 115 may initiate a refresh at a set of targeted word lines such as, for example, one, three, four, eight, or another suitable number of word lines at a given bank. After initiating the refresh at the set of targeted word lines, the memory control circuit 115 may initiate a refresh at another set of targeted word lines. Staggering the refresh of the memory array 120 may limit the peak current drawn by the memory device. In some examples, limiting the peak current at the memory device may provide power management benefits and also provide security benefits by making it more difficult for malicious actors to detect the refresh at the memory device. The memory control circuit 115 may maintain a counter to track portions of the memory array 120 that have been refreshed during the refresh 164 and those that have not yet been refreshed.

After the refresh 164 has started, but before it completes, the memory control circuit 115 executes a reset 166 of the memory device 110. This may be performed by providing a reset pulse to the memory array 120. The reset 166 may be executed before the completion of the refresh 164. After the reset 166, the memory control circuit 115 may be programmed to consider the memory array 120 corrupted. For example, values of the memory cells of the memory array 120 may be indeterminate.

In some examples, after the reset 166, the portion of memory cells at the memory array 120 that were already refreshed during the interrupted execution of the refresh 164 may have charges consistent with their previously programmed values. These charges, however, may decay with time. The portion of memory cells at the memory array 120 that were not refreshed during the interrupted execution of the refresh 164 may have charges that are determined by the startup behavior of the memory array 120. For example, the startup may occur after the reset 166.

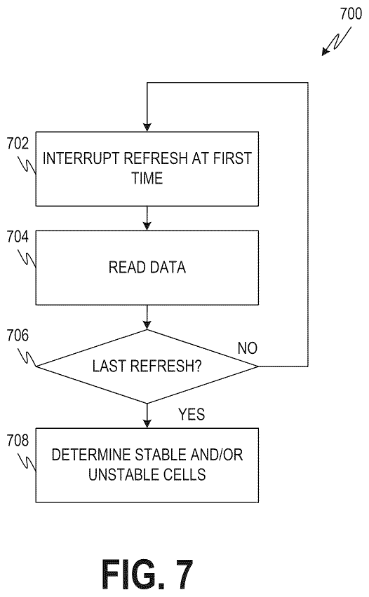

In some examples, the combination of memory cells that were refreshed in the refresh 164 and memory cells that were not refreshed during the refresh 164 have charge values based on the charge decay of the various memory cells and the startup behavior of the memory array. As described herein, this may result in random charge values at unstable memory cells of the memory array 120 and/or unique, repeatable charge values at other, stable memory cells of the memory array 120. The memory control circuit 115 may determine which memory cells of the memory array are stable and which are unstable, for example, as described herein with respect to FIG. 7.

After the reset 166, the memory control circuit 115 may perform a read 168. The read 168 may be of all or a portion of the memory cells at the array 120. In some examples, the read 168 includes memory cells that are stable and/or memory cells that are unstable. The memory control circuit 115 may utilize values read from stable memory cells to generate a cryptographic key 172, as described herein. The memory control circuit 115 may utilize values read from unstable memory cells to generate a random number 170, as described herein.

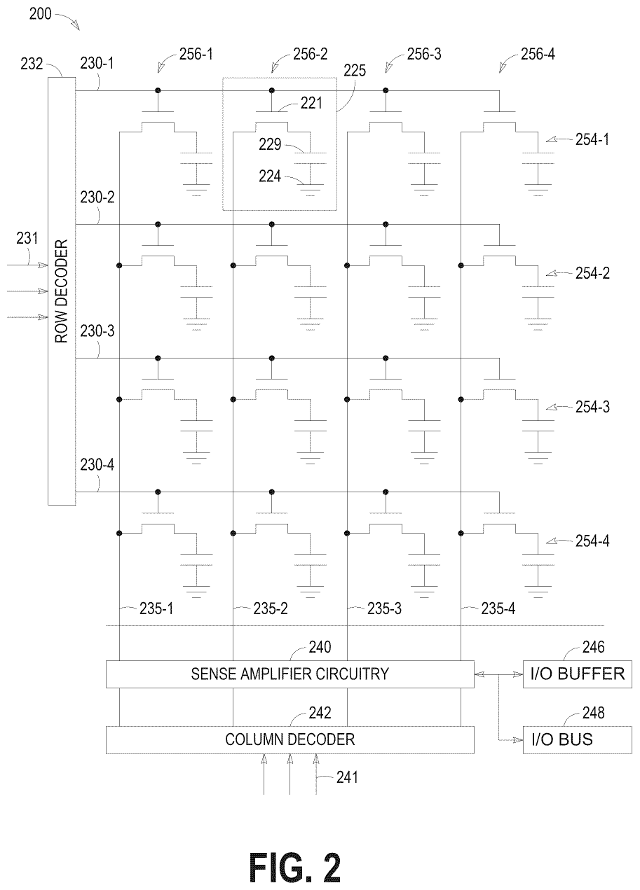

FIG. 2 is a schematic of an electrical arrangement of components of an embodiment of an example DRAM device 200 with each of the memory cells having a GAA transistor coupled to a capacitor. In some examples, the arrangement of FIG. 2 illustrates a page of memory cells as depicted and described in FIGS. 1 and 3-5. The memory cells can be coupled to bit lines (BLs), where each of the BLs may be wrapped on a sidewall of an active area of the GAA transistor of each memory cell to which the BL is coupled. Each word line (WL) can be structured by contacting gates of GAA transistors of memory cells to which the given WL is coupled. The DRAM device 200 can include an array of memory cells 225 (only one being labeled in FIG. 2 for ease of presentation) arranged in rows 254-1, 254-2, 254-3, and 254-4 and columns 256-1, 256-2, 256-3, and 256-4. The physical orientation of the rows and columns is not shown. Further, while only four rows 254-1, 254-2, 254-3, and 254-4 and four columns 256-1, 256-2, 256-3, and 256-4 of four memory cells are illustrated, DRAM devices, like DRAM device 200, can have significantly more memory cells 225 (for example, tens, hundreds, or thousands of memory cells) per row or per column.

In this example, each memory cell 225 can include a single transistor 221 and a single capacitor 229, which is commonly referred to as a 1T1C (one-transistor-one capacitor cell). One plate of capacitor 229, which can be termed the “node plate,” is connected to the drain terminal of transistor 221, whereas the other plate of the capacitor 229 is connected to ground 224 or other reference node. Each capacitor 229 within the array of 1T1C memory cells 225 typically serves to store one bit of data, and the respective transistor 221 serves as an access device to write to or read from storage capacitor 229.

The transistor gate terminals within each row of rows 254-1, 254-2, 254-3, and 254-4 are portions of respective WLs 230-1, 230-2, 230-3, and 230-4, and the transistor source terminals within each of columns 256-1, 256-2, 256-3, and 256-4 are electrically connected to respective BLs 235-1, 235-2, 235-3, and 235-4. A row decoder 232 can selectively drive the individual WLs 230-1, 230-2, 230-3, and 230-4, responsive to row address signals 231 input to row decoder 232. Driving a given WL at a high voltage causes the access transistors within the respective row to conduct, thereby connecting the storage capacitors within the row to the respective BLs, such that charge can be transferred between the BLs and the storage capacitors for read or write operations. Both read and write operations can be performed via SA circuitry 240, which can transfer bit values between memory cells 225 of the selected row of the rows 254-1, 254-2, 254-3, and 254-4 and input/output buffers 246 (for write/read operations) or external input/output data buses 248.

A column decoder 242 responsive to column address signals 241 can select which of the memory cells 225 within the selected row is read out or written to. Alternatively, for read operations, the storage capacitors 229 within the selected row can be read out simultaneously and latched, and the column decoder 242 can then select which latch bits to connect to the output data bus 248. Since read-out of the storage capacitors destroys the stored information, the read operation is accompanied by a simultaneous rewrite of the capacitor charge. Further, in between read/write operations, the capacitor charge is repeatedly refreshed to prevent data loss. Details of read/rewrite, write, and refresh operations are well-known to those of ordinary skill in the art.

DRAM device 200 can be implemented as an IC within a package that includes pins for receiving supply voltages (for example, to provide the source and gate voltages for the transistors 221) and signals (including data, address, and control signals). FIG. 2 depicts DRAM device 200 in simplified form to illustrate basic structural components, omitting many details of the memory cells 225 and associated WLs 230-1, 230-2, 230-3, and 230-4 and BLs 235-1, 235-2, 235-3, and 235-4 as well as the peripheral circuitry. For example, in addition to the row decoder 232, column decoder 242, Sense Amplifier (SA) circuitry 240, and buffers 246, DRAM device 200 can include further peripheral circuitry, such as a memory control circuit (e.g., the memory control circuit 115). The memory control circuit may control the memory operations based on control signals (provided, for example, by a host device, an external processor), additional input/output circuitry, or other features associated with a memory device. The peripheral circuitry can be located above the array of memory cells 225 in a CoA architecture using a wafer-to-wafer interconnect architecture. Alternatively, the peripheral circuitry can be located under the array of memory cells 225 in a CuA architecture. Alternatively, the peripheral circuitry can be located in a region of the IC of the memory device adjacent an array region having the array of memory cells 225.

In two-dimensional (2D) DRAM arrays, the rows 254-1, 254-2, 254-3, and 254-4 and columns 256-1, 256-2, 256-3, and 256-4 of memory cells 225 can be arranged along a single horizontal plane (i.e., a plane parallel to the layers) of the semiconductor substrate, for example, in a rectangular lattice with WLs 230-1, 230-2, 230-3, and 230-4 and BLs 235-1, 235-2, 235-3, and 235-4. In 3D DRAM arrays, the memory cells 225 can be arranged in a 3D lattice with a page of memory cells and associated WLs and BLs at a level above another page of memory cells and their associated WLs and BLs.

Memory devices having identical or similar features as example DRAM device 200 can be implemented in a variety of electronic host devices. Electronic host devices, such as mobile electronic devices (for example, smartphones, tablets, and other similar communication-related devices), electronic devices for use in automotive applications (for example, automotive sensors, control units, driver-assistance systems, passenger safety systems, comfort systems, or other similar systems), and internet-connected appliances or devices (for example, internet-of-things (IoT) devices, or other network-related devices), have varying storage needs depending on, among other things, the type of electronic device, use environment, performance expectations, or other criteria.

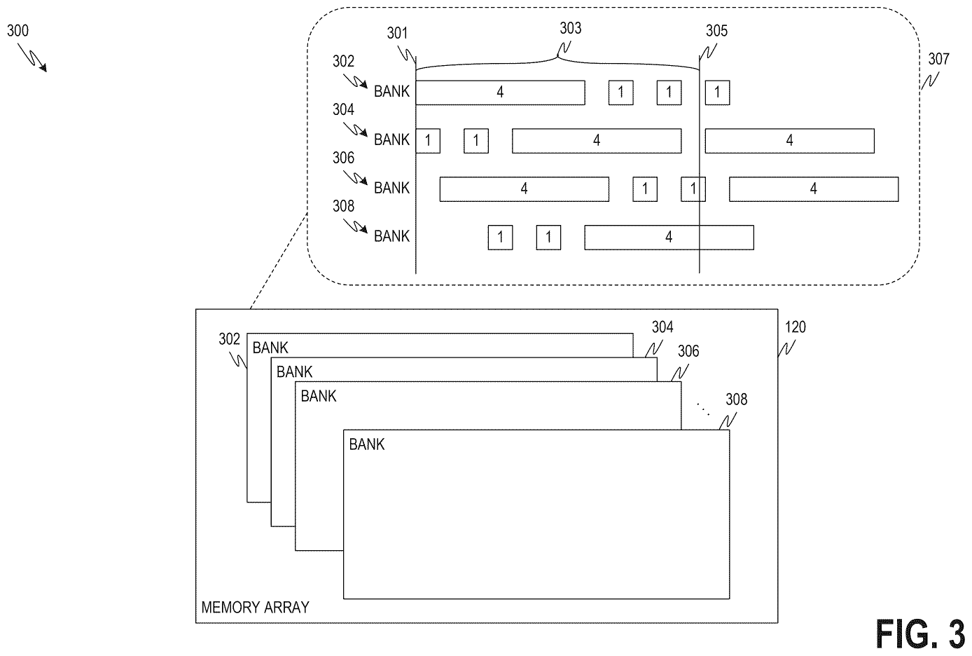

FIG. 3 is a diagram 300 showing an example arrangement of the memory array 120 and illustrating an example execution of an interrupted refresh of the memory array 120. In the example of FIG. 3, the memory array 120 includes banks 302, 304, 306, 308. Each bank 302, 304, 306, 308 may include a number of memory cells of the memory array 120.

A chart 307 illustrates a staggered refresh and reset. The chart 307 represents time from left to right. Each of the banks 302, 304, 306, 308 are represented by a row in the chart 307. At the time 301, the refresh 164 begins. The different banks 302, 304, 306, 308 may refresh in a staggered manner. For example, the example of FIG. 3 shows the bank 302 beginning a refresh of four word lines from the bank 302 at the time 301. After the refresh of four word lines is complete, the bank 302 begins three consecutive refreshes of single word lines from the bank 302. A refresh of a single word line is sometimes referred to as a row hammer refresh. In the example of the chart 307, the banks 306 and 308 do not begin refreshes immediately after the refresh of the memory array 120 is initiated at time 301, but began operations later. Also, there may be variable or delays between word line refreshes. In this way, the refreshing of the respective word lines of the banks 302, 304, 306 may be staggered.

The chart 307 also shows an example of the reset 166 at a time 305. The reset 166 may begin at a time 303 after the time 301 when the refresh was initiated. Memory cells of the array 120 that were refreshed prior to the time 305 may have a refreshed charge, which may begin to decay. Memory cells of the array 120 that were not refreshed prior to the time 305 may assume a charge state based on the startup behavior of the memory device 110.

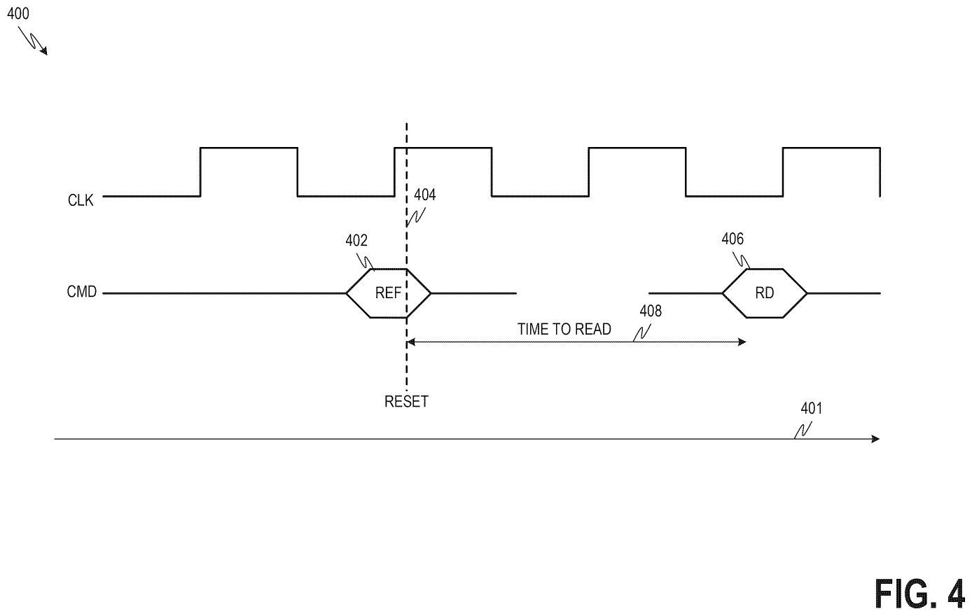

FIG. 4 is a chart 400 showing another example implementation of number generation using DRAM. The chart 400 shows a clock signal (CLK) and a command signal (CMD) illustrated with respect to a time axis 401. The clock signal CLK shows the state of an example system clock of the memory device 110. The command signal CMD shows commands executed at the memory device 110. In this example, a refresh command 402 is given and begins executing. Before the refresh is completed, a reset command 404 is provided. After the reset command 404, a read command 406 is executed. Time 408 passes between the reset command 404 and the read command 406. The time 408 may be determined by the memory control circuit 115 and/or may be a property of how the reset command 404 and/or read command 406 are executed.

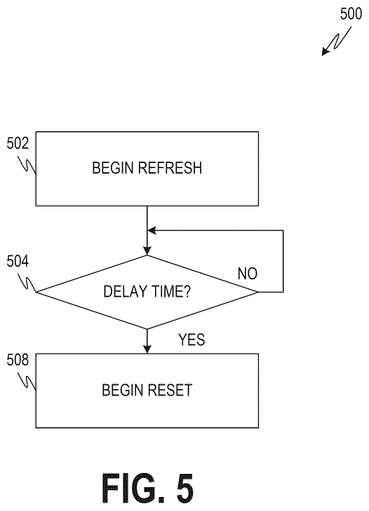

FIG. 5 is a flowchart showing one example of a process flow 500 illustrating the interrupting of a refresh at the memory device 110 of FIG. 1. At operation 502, the memory control circuit 115 may begin the refresh. At operation 504, the memory control circuit 115 may determine if a delay time has passed after the beginning of the refresh at operation 502. If the delay time has not passed, the memory control circuit 115 may wait and, again, determine at operation 504 whether the delay time has passed. When the delay time has passed, the memory control circuit 115 may begin a reset of the memory device 110 at operation 508.

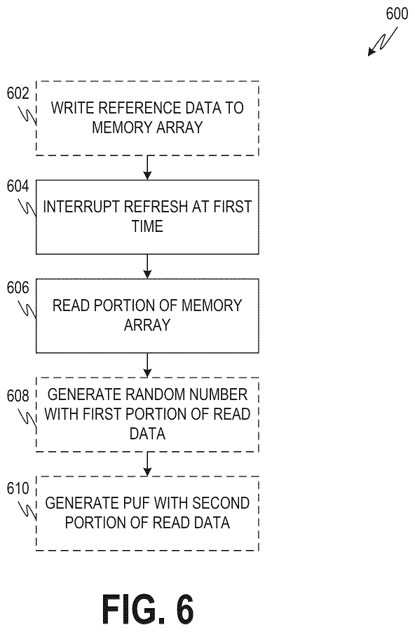

FIG. 6 is a flowchart showing one example of a process flow 600 that may be executed in the environment 100 to generate a number, such as a random number and/or a unique, repeatable number using a DRAM. At optional operation 602, the memory control circuit 115 may write reference data to the memory array 120. The reference data may be any suitable known data or random data. For example, known data may be used to generate a PUF and/or random data may be used to generate a random number. In some examples, the memory control circuit 115 may write the same reference data to the memory array 120 each time that the process flow 600 is executed.

At operation 604, the memory control circuit 115 may interrupt a refresh of the memory array 120 at a first time. Interrupting the refresh may comprise initiating the refresh and then resetting the memory device before the refresh is completed. At operation 606, the memory control circuit 115 may read a portion of the memory array 120.

At optional operation 608, the memory control circuit 115 may generate a random number with the first portion of the read data. The first portion of the read data may correspond to unstable memory cells at the memory array 120. For example, the first portion of the read data may comprise a first string of raw values read from the unstable memory cells. In some examples, the first string of raw values may be used as a random number. In other examples, the memory control circuit 115 may perform various other processing to the first string of raw values, with the result of the processing being the random number.

At optional operation 610, may generate a PUF value with a second portion of the read data. The second portion of the read data may be read from stable memory cells at the memory array. For example, the second portion of the read data may comprise a second string of values read from the stable memory cells. In some examples, the second string of raw values are unique and repeatable and, therefore, can be the PUF value. In other examples, the memory control circuit 115 performs further processing of the second string of raw values read from the stable memory cells to determine the PUF value. For example, the memory control circuit 115 may apply a cryptographic function, such as a hash function, to the second string of raw values read from the stable memory cells to generate a PUF value. For example, the second string of raw values may include one bit for each stable memory cell. In some implementations, this can result in a raw string that can include, for example, hundreds of bits, thousands of bits, tens of thousands of bits, etc. The memory control circuit 115 may include and/or utilize any suitable combination of hardware or software to apply a cryptographic function to reduce the raw string. Any suitable cryptographic function can be used such as, for example, SHA256/512. In some examples, the memory control circuit 115 is arranged to generate a PUF value of a predetermined size. For example, the PUF value can include 32 bytes, 64 bytes, or any other suitable value. When the PUF value is used as a cryptographic key, for example, a 64-byte PUF value may be suitable for Elliptic Curve Diffie Hellman (ECDH) and/or Elliptic Curve Digital Signature Algorithm (ECDSA). Also, a 32-byte PUF value may be suitable for some symmetric encryption algorithms.

It will be appreciated that at least one of the operations 608 and 610 may be performed. For example, the memory control circuit 115 may execute the process flow 600 to determine a random number only by executing operation 608 and omitting execution of operation 610. The memory control circuit 115 may also, in some examples, execute the process flow 600 to determine a PUF value only by executing the operation 610 and omitting the operation 608. Also, in some examples, the memory control circuit 115 may execute the process flow 600 to determine a random number and a PUF value by executing operations 608 and 610.

FIG. 7 is a flowchart showing one example of a process flow 700 that may be executed by the memory control circuit 115 to identify stable and unstable memory cells at the memory array 120. At operation 702, the memory control circuit 115 may interrupt a refresh of the memory array 120 at a first time after the refresh. In some examples, operation 702 may be performed by resetting the memory device 110 using a reset pulse having a common length in time.

At operation 704, the memory control circuit 115 may read data from all or a portion of the memory array 120. The read data may be stored. This may be repeated for a number of interrupted refreshes. If, at operation 706, the current refresh is not the last refresh of the number of refreshes, the memory control circuit 115 may return to operation 702 and again interrupt a refresh of the memory array 120 at the first time after the refresh.

When the last refresh of the number of refreshes is complete, the memory control circuit 115 may, at operation 708, determine stable and/or unstable memory cells from the memory array 120. This may include, for example, comparing the read data across the number of executed interrupted refreshes. Memory cells providing equivalent values over all or most of the interrupted refreshes may be considered stable. Memory cells providing random values over all or most of the interrupted refreshes may be considered unstable. The memory control circuit 115 may utilize indications of stable and/or unstable memory cells, for example, as described herein, to determine a random number and/or PUF value.

In some examples, the memory array 120 may behave differently depending on the time between the beginning of the refresh and the beginning of the reset. For example, waiting different times after the refresh to begin the reset may result in more or less of the memory cells of the memory array 120 being refreshed prior to the reset. In some examples, the time between the refresh and the reset may be selected based on the desired behavior of the memory array 120. For example, the time between the refresh and the reset may be selected to maximize the number of stable memory cells, maximize the number of unstable memory cells, achieve a desired ratio between stable and unstable memory cells, and/or the like.

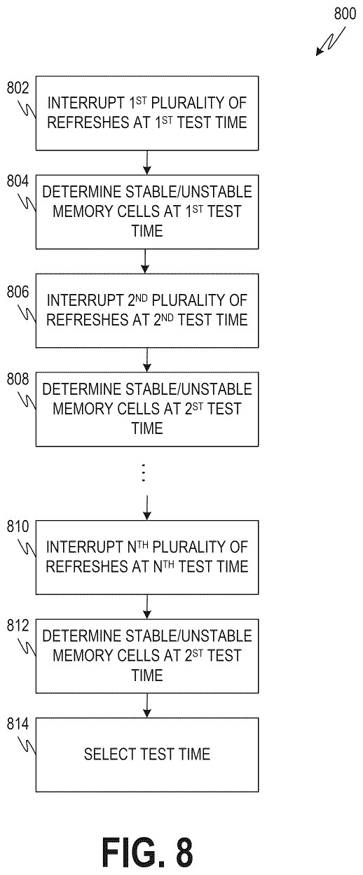

FIG. 8 is a flowchart showing one example of a process flow 800 for selecting a time between the refresh and the reset. At operation 802, the memory control circuit 115 may interrupt a first plurality of refreshes at a first test time after the respective refreshes. At operation 804, the memory control circuit 115 may determine stable and/or unstable memory cells at the first test time. This may be performed, for example, as described herein with respect to FIG. 7. At operation 806, the memory control circuit 115 may interrupt a second plurality of refreshes at a second test time after the respective refreshes. At operation 808, the memory control circuit 115 may determine stable and/or unstable memory cells at the second test time.

At operation 810, the memory control circuit 115 may interrupt an Nth plurality of refreshes at an Nth test time after the respective refreshes. At operation 812, the memory control circuit 115 may determine stable and/or unstable memory cells at the Nth test time. In various examples, any suitable number of test times may be evaluated in this manner. At operation 814, the memory control circuit 115 may select a test time for determining random number values and/or PUF values as described herein. The selected test time may be based on the number of stable memory cells at the test time, the number of unstable memory cells at the test time, a ratio of stable to unstable memory cells at the test time, and/or the like.

FIG. 9 illustrates a block diagram of an example machine 900 upon which any one or more of the techniques (e.g., methodologies) discussed herein may perform. In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, an IoT device, automotive system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

The machine (e.g., computer system) 900 (e.g., the host device 105, the memory device 110, etc. ,) may include a hardware processor 902 (e.g., a CPU, a GPU, a hardware processor core, or any combination thereof, such as the memory control circuit 115, etc.), a main memory 904, and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912, and UI navigation device 914 may be a touch screen display. The machine 900 may additionally include a storage device, a signal generation device 918 (e.g., a speaker), a network interface device 920, and one or more sensors 917, such as a global positioning system (GPS) sensor, compass, accelerometer, or other sensor. The machine 900 may include an output controller 928, such as a serial (e.g., USB, parallel, or other wired or wireless (e.g., infrared (IR), near field communication (NFC), etc.) connection to communicate or control one or more peripheral devices (e.g., a printer, card reader, etc.).

The storage device 922 may include a non-transitory machine readable medium on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 922 may constitute the machine readable medium.

While the machine readable medium is illustrated as a single medium, the term “machine readable medium” may include a single medium or multiple media (e.g., a centralized or distributed database, or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine-readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., EPROM, EEPROM) and flash memory devices; magnetic disks, such as internal hard disks and removable disks; magneto-optical disks; and CD-ROM and DVD-ROM disks.

The instructions 924 (e.g., software, programs, an operating system (OS), etc.) or other data are stored on a storage device 921, can be accessed by the memory 904 for use by the processor 902. The memory 904 (e.g., DRAM) is typically fast, but volatile, and thus a different type of storage than the storage device 921 (e.g., an SSD), which is suitable for long-term storage, including while in an “off” condition. The instructions 924 or data in use by a user or the machine 900 are typically loaded in the memory 904 for use by the processor 902. When the memory 904 is full, virtual space from the storage device 921 can be allocated to supplement the memory 904; however, because the storage device 921 device is typically slower than the memory 904, and write speeds are typically at least twice as slow as read speeds, use of virtual memory can greatly reduce user experience due to storage device latency (in contrast to the memory 904, e.g., DRAM). Further, use of the storage device 921 for virtual memory can greatly reduce the usable lifespan of the storage device 921.

In contrast to virtual memory, virtual memory compression (e.g., the Linux® kernel feature “ZRAM”) uses part of the memory as compressed block storage to avoid paging to the storage device 921. Paging takes place in the compressed block until it is necessary to write such data to the storage device 921. Virtual memory compression increases the usable size of memory 904, while reducing wear on the storage device 921.

Storage devices optimized for mobile electronic devices, or mobile storage, traditionally include MMC solid-state storage devices (e.g., micro Secure Digital (microSD™) cards, etc.). MMC devices include a number of parallel interfaces (e.g., an 8-bit parallel interface) with a host device, and are often removable and separate components from the host device. In contrast, eMMC™ devices are attached to a circuit board and considered a component of the host device, with read speeds that rival SATA based SSD devices. However, demand for mobile device performance continues to increase, such as to fully enable virtual or augmented-reality devices, utilize increasing networks speeds, etc. In response to this demand, storage devices have shifted from parallel to serial communication interfaces. UFS devices, including controllers and firmware, communicate with a host device using a low-voltage differential signaling (LVDS) serial interface with dedicated read/write paths, further advancing greater read/write speeds.

The instructions 924 may further be transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

The above detailed description includes references to the accompanying drawings, which form a part of the detailed description. The drawings show, by way of illustration, specific embodiments in which the disclosure can be practiced. These embodiments are also referred to herein as “examples,” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” may include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

In various examples, the components, controllers, processors, units, engines, or tables described herein can include, among other things, physical circuitry or firmware stored on a physical device. As used herein, “processor” means any type of computational circuit such as, but not limited to, a microprocessor, a microcontroller, a graphics processor, a digital signal processor (DSP), or any other type of processor or processing circuit, including a group of processors or multi-core devices.

The term “horizontal” as used in this document is defined as a plane parallel to the conventional plane or surface of a substrate, such as that underlying a wafer or die, regardless of the actual orientation of the substrate at any point in time. The term “vertical” refers to a direction perpendicular to the horizontal as defined above. Prepositions, such as “on,” “over,” and “under” are defined with respect to the conventional plane or surface being on the top or exposed surface of the substrate, regardless of the orientation of the substrate; and while “on” is intended to suggest a direct contact of one structure relative to another structure which it lies “on” in the absence of an express indication to the contrary); the terms “over” and “under” are expressly intended to identify a relative placement of structures (or layers, features, etc.), which expressly includes—but is not limited to—direct contact between the identified structures unless specifically identified as such. Similarly, the terms “over” and “under” are not limited to horizontal orientations, as a structure may be “over” a referenced structure if it is, at some point in time, an outermost portion of the construction under discussion, even if such structure extends vertically relative to the referenced structure, rather than in a horizontal orientation.

The terms “wafer” and “substrate” are used herein to refer generally to any structure on which integrated circuits are formed, and also to such structures during various stages of integrated circuit fabrication. The following detailed description is, therefore, not to be taken in a limiting sense, and the scope of the various embodiments is defined only by the appended claims, along with the full scope of equivalents to which such claims are entitled.

Various embodiments according to the present disclosure and described herein include memory utilizing a vertical structure of memory cells (e.g., NAND strings of memory cells). As used herein, directional adjectives will be taken relative a surface of a substrate upon which the memory cells are formed (i.e., a vertical structure will be taken as extending away from the substrate surface, a bottom end of the vertical structure will be taken as the end nearest the substrate surface and a top end of the vertical structure will be taken as the end farthest from the substrate surface).

As used herein, directional adjectives, such as horizontal, vertical, normal, parallel, perpendicular, etc., can refer to relative orientations, and are not intended to require strict adherence to specific geometric properties, unless otherwise noted. For example, as used herein, a vertical structure need not be strictly perpendicular to a surface of a substrate, but may instead be generally perpendicular to the surface of the substrate, and may form an acute angle with the surface of the substrate (e.g., between 60 and 120 degrees, etc.).

In some embodiments described herein, different doping configurations may be applied to a source-side select gate (SGS), a control gate, and a drain-side select gate (SGD), each of which, in this example, may be formed of or at least include polysilicon, with the result such that these tiers (e.g., polysilicon, etc.) may have different etch rates when exposed to an etching solution. For example, in a process of forming a monolithic pillar in a 3D semiconductor device, the SGS and the control gate may form recesses, while the SGD may remain less recessed or even not recessed. These doping configurations may thus enable selective etching into the distinct tiers (e.g., SGS, control gate, and SGD) in the 3D semiconductor device by using an etching solution (e.g., tetramethylammonium hydroxide (TMCH)).

Operating a memory cell, as used herein, includes reading from, writing to, or erasing the memory cell. The operation of placing a memory cell in an intended state is referred to herein as “programming,” and can include both writing to or erasing from the memory cell (e.g., the memory cell may be programmed to an erased state).

According to one or more embodiments of the present disclosure, a memory controller (e.g., a processor, controller, firmware, etc.) located internal or external to a memory device, is capable of determining (e.g., selecting, setting, adjusting, computing, changing, clearing, communicating, adapting, deriving, defining, utilizing, modifying, applying, etc.) a quantity of wear cycles, or a wear state (e.g., recording wear cycles, counting operations of the memory device as they occur, tracking the operations of the memory device it initiates, evaluating the memory device characteristics corresponding to a wear state, etc.)

According to one or more embodiments of the present disclosure, a memory access device may be configured to provide wear cycle information to the memory device with each memory operation. The memory device control circuitry (e.g., control logic) may be programmed to compensate for memory device performance changes corresponding to the wear cycle information. The memory device may receive the wear cycle information and determine one or more operating parameters (e.g., a value, characteristic) in response to the wear cycle information.

It will be understood that when an element is referred to as being “on,” “connected to,” or “coupled with” another element, it can be directly on, connected, or coupled with the other element or intervening elements may be present. In contrast, when an element is referred to as being “directly on,” “directly connected to,” or “directly coupled with” another element, there are no intervening elements or layers present. If two elements are shown in the drawings with a line connecting them, the two elements can be either be coupled, or directly coupled, unless otherwise indicated.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, the code can be tangibly stored on one or more volatile or non-volatile tangible computer-readable media, such as during execution or at other times. Examples of these tangible computer-readable media can include, but are not limited to, hard disks, removable magnetic disks, removable optical disks (e.g., compact discs and digital video disks), magnetic cassettes, memory cards or sticks, RAMs, ROMs, SSDs, UFS device, eMMC device, and the like.

### EXAMPLES

Example 1 is a system for generating data values, comprising: a DRAM memory array comprising number of memory cells; and a memory control circuit configured to perform operations comprising: interrupting a first refresh of the memory array at a first time after the first refresh, the first refresh of the memory array comprising: refreshing a first portion of the number of memory cells; and after refreshing the first portion of the number of memory cells, refreshing a second portion of the number of memory cells; after interrupting the first refresh of the memory array, reading a portion of the number of memory cells to generate first read data; and applying a cryptographic function to a first portion of the first read data corresponding to a first set of the number of memory cells to generate a first data value.

In Example 2, the subject matter of Example 1 optionally includes the operations further comprising using a second portion of the first read data corresponding to a second set of the number of memory cells to generate a random number.

In Example 3, the subject matter of any one or more of Examples 1-2 optionally include the interrupting of the first refresh of the memory array comprising: beginning the first refresh of the memory array; and when the first time has passed after beginning the first refresh of the memory array, resetting the memory array.

In Example 4, the subject matter of any one or more of Examples 1-3 optionally include the operations further comprising, before interrupting the first refresh of the memory array, writing reference data to the memory array.

In Example 5, the subject matter of any one or more of Examples 1-4 optionally include the operations further comprising: interrupting a second refresh of the memory array at the first time after the second refresh; after interrupting the second refresh of the memory array, reading the portion of the number of memory cells to generate second read data; interrupting a third refresh of the memory array at the first time after the third refresh; after interrupting the third refresh of the memory array, reading the portion of the number of memory cells to generate third read data; and determining, using the second read data and the third read data, that the first set of the number of memory cells are stable.

In Example 6, the subject matter of Example 5 optionally includes the interrupting of the first refresh of the memory array, the interrupting of the second refresh of the memory array, and the interrupting of the third refresh of the memory array comprising providing, to the control circuit, a refresh pulse of a first length in time.

In Example 7, the subject matter of any one or more of Examples 5-6 optionally include the determining that the first set of the number of memory cells are stable comprising determining that a portion of the second read data corresponding to the first set of the number of memory cells is equivalent to a portion of the third read data corresponding to the first set of the number of memory cells.

In Example 8, the subject matter of any one or more of Examples 5-7 optionally include the operations further comprising: determining, using the second read data and the third read data, that a second set of the number of memory cells is unstable; and using a second portion of the first read data corresponding to the second set of the number of memory cells to generate a random number.

In Example 9, the subject matter of any one or more of Examples 1-8 optionally include the operations further comprising: interrupting a first plurality of refreshes of the memory array at the first time after the respective refreshes of the first plurality of refreshes; based on the interrupting of the first plurality of refreshes, determining a size of the first set of the number of memory cells corresponding to the first time; interrupting a second plurality of refreshes of the memory array at a second time after the respective refreshes of the second plurality of refreshes, the second time being different than the first time; and based on the interrupting of the second plurality of refreshes, determining a size of the first set of the number of memory cells corresponding to the second time.

Example 10 is a method of using a DRAM memory device comprising a memory array comprising number of memory cells, the method comprising: interrupting a first refresh of the memory array at a first time after the first refresh, the first refresh of the memory array comprising: refreshing a first portion of the number of memory cells; and after refreshing the first portion of the number of memory cells, refreshing a second portion of the number of memory cells; after interrupting the first refresh of the memory array, reading a portion of the number of memory cells to generate first read data; and applying a cryptographic function to a first portion of the first read data corresponding to a first set of the number of memory cells to generate a first data value.

In Example 11, the subject matter of Example 10 optionally includes using a second portion of the first read data corresponding to a second set of the number of memory cells to generate a random number.

In Example 12, the subject matter of any one or more of Examples 10-11 optionally include the interrupting of the first refresh of the memory array comprising: beginning the first refresh of the memory array; and when the first time has passed after beginning the first refresh of the memory array, resetting the memory device.

In Example 13, the subject matter of any one or more of Examples 10-12 optionally include before interrupting the first refresh of the memory array, writing reference data to the memory array.

In Example 14, the subject matter of any one or more of Examples 10-13 optionally include interrupting a second refresh of the memory array at the first time after the second refresh; after interrupting the second refresh of the memory array, reading the portion of the number of memory cells to generate second read data; interrupting a third refresh of the memory array at the first time after the third refresh; after interrupting the third refresh of the memory array, reading the portion of the number of memory cells to generate third read data; and determining, using the second read data and the third read data, that the first set of the number of memory cells are stable.

In Example 15, the subject matter of Example 14 optionally includes the interrupting of the first refresh of the memory array, the interrupting of the second refresh of the memory array, and the interrupting of the third refresh of the memory array comprising providing, to a control circuit of the memory device, a refresh pulse of a first length in time.

In Example 16, the subject matter of any one or more of Examples 14-15 optionally include the determining that the first set of the number of memory cells are stable comprising determining that a portion of the second read data corresponding to the first set of the number of memory cells is equivalent to a portion of the third read data corresponding to the first set of the number of memory cells.

In Example 17, the subject matter of any one or more of Examples 14-16 optionally include determining, using the second read data and the third read data, that a second set of the number of memory cells is unstable; and using a second portion of the first read data corresponding to the second set of the number of memory cells to generate a random number.

In Example 18, the subject matter of any one or more of Examples 10-17 optionally include interrupting a first plurality of refreshes of the memory array at the first time after the respective refreshes of the first plurality of refreshes; based on the interrupting of the first plurality of refreshes, determining a size of the first set of the number of memory cells corresponding to the first time; interrupting a second plurality of refreshes of the memory array at a second time after the respective refreshes of the second plurality of refreshes, the second time being different than the first time; and based on the interrupting of the second plurality of refreshes, determining a size of the first set of the number of memory cells corresponding to the second time.

Example 19 is a non-transitory computer readable medium having instructions thereon that, when executed by at least one processor, causes the processor to perform operations comprising: interrupting a first refresh of a memory array at a first time after the first refresh, the memory array comprising number of memory cells, and the first refresh of the memory array comprising: refreshing a first portion of the number of memory cells; and after refreshing the first portion of the number of memory cells, refreshing a second portion of the number of memory cells; after interrupting the first refresh of the memory array, reading a portion of the number of memory cells to generate first read data; and applying a cryptographic function to a first portion of the first read data corresponding to a first set of the number of memory cells to generate a first data value.

In Example 20, the subject matter of Example 19 optionally includes the operations further comprising using a second portion of the first read data corresponding to a second set of the number of memory cells to generate a random number.

The above description is intended to be illustrative, and not restrictive. For example, the above-described examples (or one or more aspects thereof) may be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

What is claimed is:

1. A system for generating data values, comprising:
a DRAM memory array comprising number of memory cells; and
a memory control circuit configured to perform operations comprising:
interrupting a first refresh of the memory array at a first time after the first refresh, the first refresh of the memory array comprising:
refreshing a first portion of the number of memory cells; and
after refreshing the first portion of the number of memory cells, refreshing a second portion of the number of memory cells;
after interrupting the first refresh of the memory array, reading a portion of the number of memory cells to generate first read data; and
applying a cryptographic function to a first portion of the first read data corresponding to a first set of the number of memory cells to generate a first data value.

2. The system of claim 1, the operations further comprising using a second portion of the first read data corresponding to a second set of the number of memory cells to generate a random number.

3. The system of claim 1, the interrupting of the first refresh of the memory array comprising:
beginning the first refresh of the memory array; and
when the first time has passed after beginning the first refresh of the memory array, resetting the memory array.

4. The system of claim 1, the operations further comprising, before interrupting the first refresh of the memory array, writing reference data to the memory array.

5. The system of claim 1, the operations further comprising:
interrupting a second refresh of the memory array at the first time after the second refresh;
after interrupting the second refresh of the memory array, reading the portion of the number of memory cells to generate second read data;
interrupting a third refresh of the memory array at the first time after the third refresh;
after interrupting the third refresh of the memory array, reading the portion of the number of memory cells to generate third read data; and
determining, using the second read data and the third read data, that the first set of the number of memory cells are stable.

6. The system of claim 5, the interrupting of the first refresh of the memory array, the interrupting of the second refresh of the memory array, and the interrupting of the third refresh of the memory array comprising providing, to the control circuit, a refresh pulse of a first length in time.

7. The system of claim 5, the determining that the first set of the number of memory cells are stable comprising determining that a portion of the second read data corresponding to the first set of the number of memory cells is equivalent to a portion of the third read data corresponding to the first set of the number of memory cells.

8. The system of claim 5, the operations further comprising:
determining, using the second read data and the third read data, that a second set of the number of memory cells is unstable; and
using a second portion of the first read data corresponding to the second set of the number of memory cells to generate a random number.

9. The system of claim 1, the operations further comprising:
interrupting a first plurality of refreshes of the memory array at the first time after the respective refreshes of the first plurality of refreshes;
based on the interrupting of the first plurality of refreshes, determining a size of the first set of the number of memory cells corresponding to the first time;
interrupting a second plurality of refreshes of the memory array at a second time after the respective refreshes of the second plurality of refreshes, the second time being different than the first time; and
based on the interrupting of the second plurality of refreshes, determining a size of the first set of the number of memory cells corresponding to the second time.

10. A method of using a DRAM memory device comprising a memory array comprising number of memory cells, the method comprising:
interrupting a first refresh of the memory array at a first time after the first refresh, the first refresh of the memory array comprising:
refreshing a first portion of the number of memory cells; and
after refreshing the first portion of the number of memory cells, refreshing a second portion of the number of memory cells;
after interrupting the first refresh of the memory array, reading a portion of the number of memory cells to generate first read data; and
applying a cryptographic function to a first portion of the first read data corresponding to a first set of the number of memory cells to generate a first data value.

11. The method of claim 10, further comprising using a second portion of the first read data corresponding to a second set of the number of memory cells to generate a random number.

12. The method of claim 10, the interrupting of the first refresh of the memory array comprising:
beginning the first refresh of the memory array; and
when the first time has passed after beginning the first refresh of the memory array, resetting the memory device.

13. The method of claim 10, further comprising, before interrupting the first refresh of the memory array, writing reference data to the memory array.

14. The method of claim 10, further comprising:
interrupting a second refresh of the memory array at the first time after the second refresh;
after interrupting the second refresh of the memory array, reading the portion of the number of memory cells to generate second read data;
interrupting a third refresh of the memory array at the first time after the third refresh;
after interrupting the third refresh of the memory array, reading the portion of the number of memory cells to generate third read data; and
determining, using the second read data and the third read data, that the first set of the number of memory cells are stable.

15. The method of claim 14, the interrupting of the first refresh of the memory array, the interrupting of the second refresh of the memory array, and the interrupting of the third refresh of the memory array comprising providing, to a control circuit of the memory device, a refresh pulse of a first length in time.

16. The method of claim 14, the determining that the first set of the number of memory cells are stable comprising determining that a portion of the second read data corresponding to the first set of the number of memory cells is equivalent to a portion of the third read data corresponding to the first set of the number of memory cells.

17. The method of claim 14, further comprising:
determining, using the second read data and the third read data, that a second set of the number of memory cells is unstable; and
using a second portion of the first read data corresponding to the second set of the number of memory cells to generate a random number.

18. The method of claim 10, further comprising:
interrupting a first plurality of refreshes of the memory array at the first time after the respective refreshes of the first plurality of refreshes;
based on the interrupting of the first plurality of refreshes, determining a size of the first set of the number of memory cells corresponding to the first time;
interrupting a second plurality of refreshes of the memory array at a second time after the respective refreshes of the second plurality of refreshes, the second time being different than the first time; and
based on the interrupting of the second plurality of refreshes, determining a size of the first set of the number of memory cells corresponding to the second time.

19. A non-transitory computer readable medium having instructions thereon that, when executed by at least one processor, causes the processor to perform operations comprising:
interrupting a first refresh of a memory array at a first time after the first refresh, the memory array comprising number of memory cells, and the first refresh of the memory array comprising:
refreshing a first portion of the number of memory cells; and
after refreshing the first portion of the number of memory cells, refreshing a second portion of the number of memory cells;
after interrupting the first refresh of the memory array, reading a portion of the number of memory cells to generate first read data; and
applying a cryptographic function to a first portion of the first read data corresponding to a first set of the number of memory cells to generate a first data value.

20. The non-transitory computer readable medium of claim 19, the operations further comprising using a second portion of the first read data corresponding to a second set of the number of memory cells to generate a random number.
